(19) United States
(12) Patent Application Publication
(10) Pub. No.: US 2026/0353320 A1
(43) Pub. Date: Nov. 5, 2026

(54) ON-DEMAND SSB TRANSMISSION

(71) Applicant: LENOVO (BEIJING) LIMITED, Beijing (CN)

(72) Inventors: Zhi Yan, Beijing (CN); Hongmei Liu, Beijing (CN); Yuantao Zhang, Beijing (CN); Ruixiang Ma, Beijing (CN); Haiming Wang, Beijing (CN)

(21) Appl. No.: 19/112,454

(22) PCT Filed: Sep. 29, 2022
(86) PCT No.: PCT/CN2022/122548

§ 371 Date: Mar. 17, 2025

(51) Int. Cl. H04W 56/00

(52) U.S. Cl. CPC H04W 56/0015

(57) ABSTRACT

Methods and apparatuses for on-demand SSB transmission are disclosed. In one embodiment, a UE comprises a transceiver; and a processor coupled to the transceiver, wherein the processor is configured to receive, via the transceiver, a first SSB configuration in system information, wherein the first SSB configuration is associated with first SSBs in a first resource; and receive, via the transceiver, a second SSB configuration, wherein the second SSB configuration is associated with second SSBs in a second resource. In some embodiment, the second SSBs are additional SSBs in addition to the first SSBs and/or reduction (s) from the first SSBs.

### FIELD

The subject matter disclosed herein generally relates to wireless communications, and more particularly relates to methods and apparatuses for on-demand SSB transmission.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), synchronization signal block (SSB), Physical Broadcast Channel (PBCH), Primary Synchronization Signal (PSS), Secondary Synchronization Signal (SSS), Demodulation reference signal (DMRS), sub-carrier space (SCS), Downlink Control Information (DCI), wake-up signal (WUS), Radio Network Temporary Identifier (RNTI), transmit-receive point (TRP), Physical Downlink Control Channel (PDCCH), Time Division Duplex (TDD).

SS Block (SSB) stands for Synchronization Signal Block, and refers to Synchronization/PBCH block because synchronization signal and PBCH channel are packed as a single block that always transmit together. The components of SSB include synchronization signal and PBCH, where synchronization signal includes PSS (Primary Synchronization Signal) and SSS (Secondary Synchronization Signal); PBCH includes PBCH DMRS and PBCH data. Each SSB occupies 4 symbols in time domain.

The SSB transmission periodicity can be set via RRC parameter ssb-PeriodicityServingCell which can take values in the range of {5 ms, 10 ms, 20 ms, 40 ms, 80 ms, 160 ms}. For all frequency ranges, a default SSB transmission periodicity (SSB period) is 20 ms.

Within each SSB transmission periodicity, a number of SSBs will be transmitted in different directions called as beams during a 5 ms period, which is an SSB burst. The SSB burst is always confined to a 5 ms window, and is either located in a first half or a second (or last) half of a 10 ms radio frame. Within the 5 ms period (or window) of the SSB burst, the number of possible candidate SSB locations is L. The maximum number of candidates SSBs (Lmax) within one SSB burst depends on carrier frequency. In a 5 ms half frame, the OFDM symbol index for a candidate SSB within a SSB burst depends on SCS and frequency (or band), as show in Table 1. The SSB can be transmitted on any of the candidate SSB locations.

TABLE 1

| | OFDM starting | | | |
|---|---|---|---|---|
| | symbols of the | fc <= 3 GHz | 3 GHz < fc < 6 GHz | fc > 6 GHz |
| SCS | candidate SSBs | Lmax = 4 | Lmax = 8 | Lmax = 64 |
| Case A: | {2, 8} + 14n | n = 0, 1 | n = 0, 1, 2, 3 | NA |
| 15 kHz | | {2, 8, 16, 22} | {2, 8, 26, 22, 30, 36, | |
| | | | 44, 50} | |
| Case B: | {4, 8, 16, 20} + 28n | n = 0, | n = 0, 1 | NA |
| 30 kHz | | {4, 8, 16, 20} | | |
| Case C | {2, 8} + 14n | n = 0, 1 | n = 0, 1, 2, 3 | n = 0, 1, 2, 3, 5, 6, 7, 8, 10, |
| 30 kHz | | {2, 8, 16, 22} | | 11, 12, 13, 15, 16, 17, 18 |
| Case D | {4, 8, 16, 20} + 28n | NA | NA | n = 0, 1, 2, 3 |
| 120 kHz | | | | |
| Case E | {8, 12, 16, 20, 32, 36, | NA | NA | n = 0, 1, 2, 3, 4, 5, 6, 7 |
| 240 kHz | 40, 44} + 56n | | | |

FIG. 1 illustrates an example of the SSB transmission periodicity and the SSB burst in Case A (e.g., for fc<=3 GHz). In the example of FIG. 1, the SSB transmission periodicity is 20 ms. The SSB burst is in the first half of a first radio frame of 10 ms in each 20 ms SSB transmission periodicity. In each SSB burst, there are two SSBs: SSB Index #0 and SSB Index #1, each of which is associated with a different direction (or a different beam). In FIG. 1, the starting OFDM symbols of SSB Index #0 and SSB Index #1 are transmitted on {2,8}+14n (n=0), respectively. No SSBs are transmitted on possible candidate SSB locations {2, 8}+14n (n=1) It means that the maximal number of candidate SSBs within this SSB burst is Lmax=4, and the actual number SSBs within this SSB burst is L=2, which can be less than Lmax.

The SSB transmission periodicity is indicated (configured or reconfigured) to the UE in SIB. The UE detects the SSB(s) according to the SSB transmission periodicity.

Network energy saving is widely discussed. To save power from network side, it is favorable to have longer SSB transmission periodicity. On the other hand, shorter periodicity facilitates faster cell search for UEs. In view of the above, it is desirable to support on-demand SSB transmission.

This invention targets on-demand SSB transmission.

### BRIEF SUMMARY

Methods and apparatuses for on-demand SSB transmission are disclosed.

In one embodiment, a UE comprises a transceiver; and a processor coupled to the transceiver, wherein the processor is configured to receive, via the transceiver, a first SSB configuration in system information, wherein the first SSB configuration is associated with first SSBs in a first resource; and receive, via the transceiver, a second SSB configuration, wherein the second SSB configuration is associated with second SSBs in a second resource. In some embodiment, the second SSBs are additional SSBs in addition to the first SSBs and/or reduction(s) from the first SSBs.

In some embodiment, the processor is configured to receive, via the transceiver, the second SSB configuration in an RRC signaling message or in a control signal.

In some embodiment, the processor is configured to receive, via the transceiver, multiple second SSB configurations in an RRC signaling message, and the processor is further configured to receive, via the transceiver, an SSB indicator indicating one of the multiple second SSB configurations based on a position index indicating the position of the one second SSB configuration in a control signal. In some embodiment, the SSB indicator is included in a network energy saving indicator based on a position index indicating the position of the network energy saving indicator in the control signal, and the network energy saving indicator further includes at least one of indication of power signal information, indication of antenna port information, indication of TRP number information, and indication of cell transmission ON and OFF information.

In some embodiment, the second SSB configuration includes at least one of SSB transmission physical resource, SSB transmission pattern, and SSB transmission beam information. The SSB transmission physical resource may include second SSB transmission periodicity, or a scaling factor to a reference SSB transmission periodicity which is one of SSB transmission periodicity of the first SSBs, a reference periodicity configured by higher layer, and a default SSB transmission periodicity. The SSB transmission pattern may include SSB transmissions OFF or ON in the first or the last M1 SSB bursts within a configured period, SSB transmissions OFF or ON for M2 SSB bursts from a first reference time, and additional SSB transmission in consecutive M3 SSB bursts after a second reference time, where, each of M1, M2 and M3 is a preconfigured positive integer.

In some embodiment, the processor is further configured to transmit, via the transceiver, a WUS in a WUS resource, and the WUS resource is associated with the first SSB configuration or the second SSB configuration. The processor may be further configured to monitor, via the transceiver, a control signal after the WUS transmission within a window length, the window length is configured by higher layer. The WUS resource may be determined by the first SSB resource or the second SSB resource. In particular, the WUS resource is a first time offset after the first SSB resource or a second time offset before the second SSB resource. The periodicity of the WUS resource may be one or multiple of the periodicity of the first SSB resource or the second SSB resource. The WUS resource may be associated with SSB beam(s), and the second SSB(s) in the second SSB resource are associated with the SSB beam(s).

In another embodiment, a method performed at a UE receiving a first SSB configuration in system information, wherein the first SSB configuration is associated with first SSBs in a first resource; and receiving a second SSB configuration, wherein the second SSB configuration is associated with second SSBs in a second resource. In some embodiment, the second SSBs are additional SSBs in addition to the first SSBs and/or reduction(s) from the first SSBs.

In still another embodiment, a base unit comprises a processor; and a transceiver coupled to the processor, wherein the processor is configured to transmit, via the transceiver, a first SSB configuration in system information, wherein the first SSB configuration is associated with first SSBs in a first resource; and transmit, via the transceiver, a second SSB configuration, wherein the second SSB configuration is associated with second SSBs in a second resource. In some embodiment, the second SSBs are additional SSBs in addition to the first SSBs and/or reduction(s) from the first SSBs.

In some embodiment, the processor is configured to transmit, via the transceiver, the second SSB configuration in an RRC signaling message or in a control signal.

In some embodiment, the processor is configured to transmit, via the transceiver, multiple second SSB configurations in an RRC signaling message, and the processor is further configured to transmit, via the transceiver, an SSB indicator indicating one of the multiple second SSB configurations based on a position index indicating the position of the one second SSB configuration in a control signal. In some embodiment, the SSB indicator is included in a network energy saving indicator based on a position index indicating the position of the network energy saving indicator in the control signal, and the network energy saving indicator further includes at least one of indication of power signal information, indication of antenna port information, indication of TRP number information, and indication of cell transmission ON and OFF information.

In some embodiment, the second SSB configuration includes at least one of SSB transmission physical resource, SSB transmission pattern, and SSB transmission beam information. The SSB transmission physical resource may include second SSB transmission periodicity, or a scaling factor to a reference SSB transmission periodicity which is one of SSB transmission periodicity of the first SSBs, a reference periodicity configured by higher layer, and a default SSB transmission periodicity. The SSB transmission pattern may include SSB transmissions OFF or ON in the first or the last M1 SSB bursts within a configured period, SSB transmissions OFF or ON for M2 SSB bursts from a first reference time, and additional SSB transmission in consecutive M3 SSB bursts after a second reference time, where, each of M1, M2 and M3 is a preconfigured positive integer.

In some embodiment, the processor is further configured to receive, via the transceiver, a WUS in a WUS resource, and the WUS resource is associated with the first SSB configuration or the second SSB configuration. The processor may be configured to transmit, via the transceiver, a control signal after the WUS reception within a window length. The WUS resource may be determined by the first SSB resource or the second SSB resource. In particular, the WUS resource is a first time offset after the first SSB resource or a second time offset before the second SSB resource. The periodicity of the WUS resource may be one or multiple of the periodicity of the first SSB resource or the second SSB resource. The WUS resource may be associated with SSB beam(s), and the second SSBs) in the second SSB resource are associated with the SSB beam(s).

In yet another embodiment, a method performed at a base unit comprises transmitting a first SSB configuration in system information, wherein the first SSB configuration is associated with first SSBs in a first resource; and transmitting a second SSB configuration, wherein the second SSB configuration is associated with second SSBs in a second resource. In some embodiment, the second SSBs are additional SSBs in addition to the first SSBs and/or reduction(s) from the first SSBs.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of the SSB transmission periodicity and the SSB burst;

FIG. 2 illustrates an example of the scaling factor G=2;

FIGS. 3(a) and 3(b) illustrate an example of the scaling factor G=0.25;

FIG. 4 illustrates an example of SSB transmissions OFF in the last 1 SSB burst every 80 ms;

FIG. 5 illustrates an example of SSB transmissions OFF in 2 SSB bursts from a reference time;

FIG. 6 illustrates an example of additional SSB transmissions in consecutive 2 SSB bursts after a reference time;

FIG. 7 illustrates an example of the common DCI including multiple SSB indicators;

FIG. 8 illustrates an example of the common DCI including multiple network energy saving indicators;

FIG. 9 illustrates an example of the new SSB configuration including both type #1 and type #2;

FIG. 10 illustrates an example of WUS resource associated with legacy SSB configuration;

FIG. 11 is a schematic flow chart diagram illustrating an embodiment of a method;

FIG. 12 is a schematic flow chart diagram illustrating another embodiment of a method; and

FIG. 13 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The background part describes SSB transmission periodicity indicated in SIB. In addition, within each SSB transmission periodicity, SSBs associated with different beam(s) are actually transmitted in a SSB burst of 5 ms which is in the first half or the last half of a radio frame of 10 ms. It means that SSB transmission can be ON or OFF for different beams within SSB burst of 5 ms or for different SSB bursts, which can be referred to as SSB transmission pattern. The number of SSBs transmitted in an SSB burst corresponds to the number of beams by each of which the SSB is transmitted. The actual SSBs transmitted in an SSB burst corresponds to the beams by each of which the SSB is transmitted can be referred to as SSB transmission beam information.

In the following description, SSB transmission physical resource (e.g., SSB transmission periodicity), SSB transmission pattern, SSB transmission beam information (e.g., SSB beam index, all beams), etc are collectively referred to as SSB configuration.

In the following description, the SSB transmission periodicity indicated in system information (e.g., SIB) is referred to as legacy SSB transmission periodicity or first SSB transmission periodicity. The SSB transmission ON and OFF based on the legacy SSB transmission periodicity is referred to as legacy (or first) SSB transmission pattern. The SSB transmission beam information based on the legacy SSB transmission periodicity is referred to as legacy (or first) SSB transmission beam information. In addition, the legacy (or first) SSB transmission periodicity, the legacy (or first) SSB transmission pattern and the legacy (or first) SSB transmission beam information are collectively referred to as legacy SSB configuration or first SSB configuration.

To support SSB transmission update, a new SSB configuration referred to as second SSB configuration is introduced. The second SSB configuration includes the difference from the first SSB configuration. It means that when the second SSB configuration is triggered, additional SSBs in addition to SSBs transmitted according to the first SSB configuration are transmitted, and/or some SSBs transmitted according to the first SSB configuration are reduced (or OFF, i.e., not transmitted).

A first embodiment relates to the composition of the second SSB configuration.

As described above, the first SSB configuration includes first SSB transmission physical resource (e.g., first SSB transmission periodicity), first SSB transmission pattern, first SSB transmission beam information (e.g., SSB beam index, all beams), etc. The second SSB configuration differs from the first SSB configuration in at least one of the SSB transmission physical resource, the SSB transmission pattern, and the SSB transmission beam information.

In the following description, the different SSB transmission physical resource (e.g., SSB transmission periodicity) is referred to as new (or second) SSB transmission physical resource (e.g., new SSB transmission periodicity); the different SSB transmission pattern is referred to as new (or second) SSB transmission pattern, and the different SSB transmission beam information is referred to as new (or second) SSB transmission beam information.

A first sub-embodiment of the first embodiment relates to new SSB transmission physical resource (e.g., new SSB transmission periodicity).

A new SSB transmission periodicity, which may be different from the first SSB transmission periodicity in the first SSB configuration, can be set in a same manner as legacy, i.e., selected from a set of candidate SSB transmission periodicities {5 ms, 10 ms, 20 ms, 40 ms, 80 ms, 160 ms}. In addition, the set of candidate SSB transmission periodicities can be expanded to {5 ms, 10 ms, 20 ms, 40 ms, 80 ms, 160 ms, 320 ms}.

Alternatively, the new SSB transmission periodicity can be scaled up or down based on a reference periodicity. For example, the reference periodicity can be one of: the first SSB transmission periodicity in the first SSB configuration, a reference periodicity configured by higher layer, a default SSB transmission periodicity for UE in IDLE state. In particular, if the reference periodicity is denoted as T, the new SSB transmission periodicity (Tnew) can be denoted as Tnew=T*G, where G is a scaling factor.

For example, the scaling factor can be selected from a set of candidate scaling factors, e.g., {0.25, 0.5, 1, 2}.

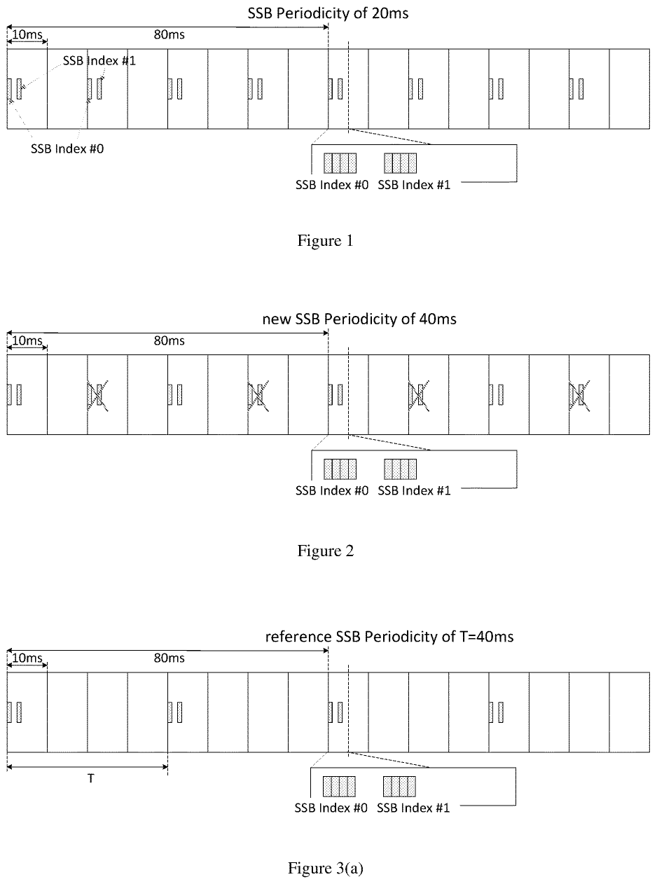

If the scaling factor is larger than 1 (G>1), the new SSB transmission periodicity (Tnew) becomes larger. So, SSB transmissions in the first or last (G-1) SSB burst(s) every reference periodicity (e.g., G SSB bursts according to the first SSB configuration) are OFF (i.e., not transmitted). It means that the new SSB transmission periodicity included in the second SSB configuration will reduce the SSB transmissions according to the first SSB configuration. FIG. 2 illustrates an example of G=2. The first SSB transmission periodicity T=20 ms. The new SSB transmission periodicity Tnew=T*G=20*2=40 ms. The SSB transmissions in the last 1 (=G-1=2-1) SSB burst every 2 SSB bursts according to the first SSB configuration (in particular, according to the first SSB transmission periodicity included in the first SSB configuration) are reduced or OFF (i.e., not transmitted).

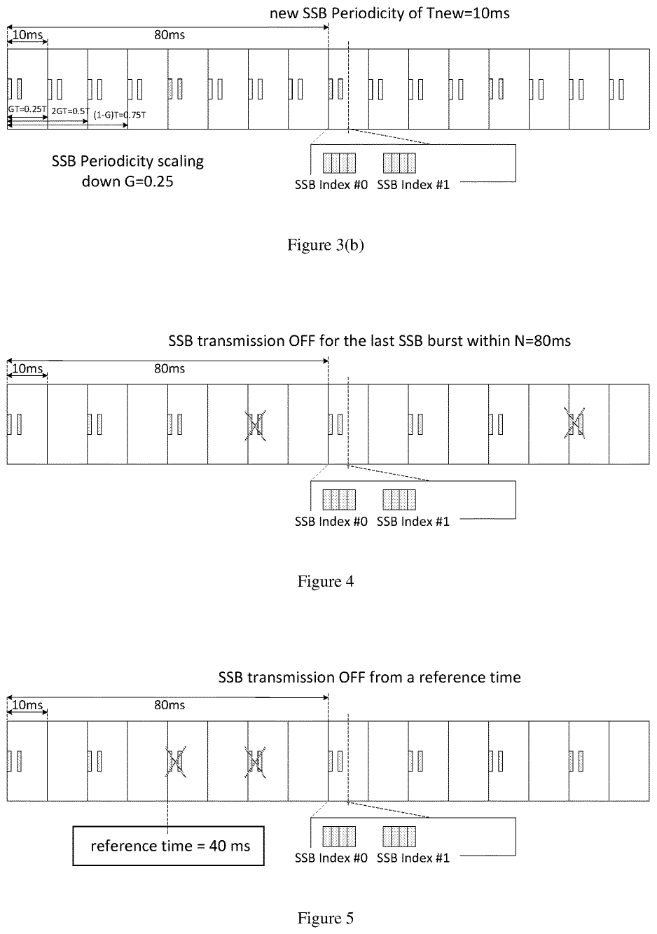

If the scaling factor is smaller than 1 (G<1), SSB transmissions are added between two neighboring (or consecutive) reference SSB bursts (e.g., two consecutive SSB bursts according to the first SSB transmission periodicity included in the first SSB configuration). SSB transmissions are added in new SSB burst(s) starting from {GT, 2GT, . . . , (1-G)T} after each reference SSB burst. FIG. 3(a) illustrates a reference SSB transmission periodicity (e.g., the first SSB transmission periodicity) T=40 ms. FIG. 3(b) illustrates an example of the scaling factor G=0.25. In the example of FIG. 3(b), new SSB transmission periodicity Tnew=T*G=40*0.25=10 ms. The SSB transmissions are added in new SSB bursts starting from {0.25*T, 2*0.25*T, (1−0.25)*T}={0.25*40, 2*0.25*40, (1−0.25)*40}={10, 20, 30} ms after each reference SSB burst.

A second sub-embodiment of the first embodiment relates to new SSB transmission pattern.

In legacy, within each SSB transmission periodicity, one or multiple SSBs in an SSB burst of 5 ms are transmitted. It can be referred to as first SSB transmission pattern. Take first SSB transmission as baseline SSB transmission, the SSB transmission pattern includes the part of the first SSB transmission ON while the remaining first SSB transmission OFF with periodic or aperiodic manner.

The new SSB transmission pattern may include at least the following (1) to (3):
(1) SSB transmissions OFF or ON in the first or the last M SSB bursts every N ms. M and N can be configured by higher layer signaling. For example, N can be configures as 80 ms, which is a boundary duration of PBCH.

FIG. 4 illustrates an example of SSB transmissions OFF in the last 1 SSB burst every 80 ms. In FIG. 4, the SSB transmission periodicity is 20 ms. In the last SSB burst (i.e., the last 20 ms) of the boundary duration of 80 ms, the SSB transmissions are OFF (i.e., SSBs are not transmitted in said 20 ms).
(2) SSB transmissions OFF or ON in M SSB bursts from a reference time. M can be configured by higher layer signaling. The reference time can be for example being associated with time slot indicated to the UE, e.g., by DCI.

FIG. 5 illustrates an example of SSB transmissions OFF in 2 SSB bursts from a reference time (e.g., 40 ms).
(3) Additional SSB transmission(s) in consecutive S SSB burst(s) (or within a window length) after a reference time. S can be configured by higher layer signaling. The window length and the reference time can be associated with time slot or symbol indicated to the UE, e.g., by DCI.

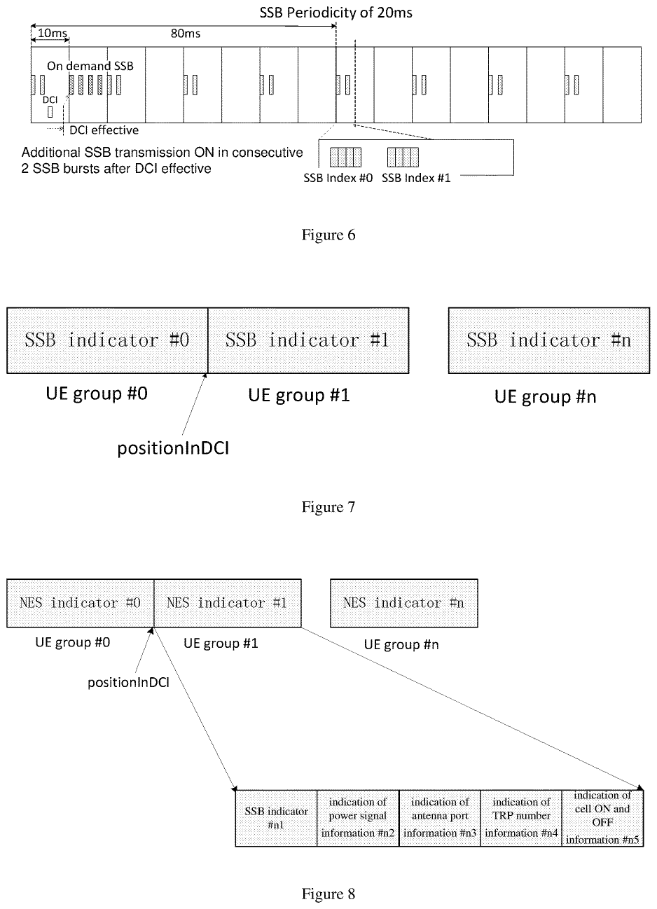

FIG. 6 illustrates an example of additional SSB transmissions in consecutive 2 SSB bursts after the reference time (e.g., time slot or symbol when DCI or RRC is effective or applicable). The DCI effective time can refer to a symbol that is several symbols after receiving a DCI.

It can be seen that the new transmission pattern (1) is periodic, while the new transmission pattern (2) and the new transmission pattern (3) are aperiodic (or referred to as one-shot). The aperiodic new transmission pattern facilitates the DL synchronization and measurement for urgent UE(s). It means that the aperiodic new transmission pattern can be applicable only for a single UE or a group of UEs.

A third sub-embodiment of the first embodiment relates to new transmission beam information.

Within each SSB burst, a number of SSBs are transmitted, where the number of SSBs corresponds to the number of beams. The new transmission beam information refers to new beam(s) (e.g., denoted by new beam index (or indices), or by all available beams).

For example, in the first SSB configuration, two SSBs, each is associated with an SSB beam of two SSB beams, are transmitted in each SSB burst. In the second SSB configuration, the added SSB may only be transmitted by one of the two SSB beams.

A second embodiment relates to indication of the new SSB configuration.

The first SSB configuration (or the legacy SSB configuration) is indicated (i.e., configured or reconfigured) in SIB, i.e., in SI information update. It means that the legacy SSB configuration is indicated to the UEs by SIB.

According to a first sub-embodiment of the second embodiment, the new SSB configuration is also indicated (i.e., configured or reconfigured) in SIB, i.e., in the same manner as the first SSB configuration.

According to a second sub-embodiment of the second embodiment, the new SSB configuration is indicated to the UE in UE-specific RRC configuration, e.g., by a RRC signaling.

The new SSB transmission periodicity, if being selected from a set of candidate SSB transmission periodicities having 6 or 7 different values, a 3-bit indication is necessary for the RRC signaling to indicate the new SSB transmission periodicity.

The new SSB transmission periodicity, if being indicated by a scaling factor selected from a set of candidate scaling factors having 4 values, a 2-bit indication is necessary for the RRC signaling to indicate the new SSB transmission periodicity.

According to a third sub-embodiment of the second embodiment, the new SSB configuration is indicated to the UE(s) by a DCI. The DCI can be a common DCI, which is optionally differentiated by new RNTI.

The common DCI may include multiple new SSB configurations, each of which is associated with a group of UEs. Each UE is configured with a higher layer signaling (e.g., positionlnDCI) to indicate the position of the new SSB configuration in the common DCI that is associated with the UE. For example, the UEs in the same group of UEs are configured with the same positionlnDCI.

Alternatively, the common DCI may include multiple SSB indicators, each of which indicates a new SSB configuration and is associated with a group of UEs. A new SSB configuration may include indication of at least one of new SSB transmission physical resource (e.g., new SSB transmission periodicity), new SSB transmission pattern, and new SSB transmission beam information, as described in the first embodiment. The UE is configured with multiple new SSB configurations each of which is identified by an SSB indicator. The UE is also configured with a higher layer signaling positionInDCI to indicate the position of the SSB indicator in the common DCI that is associated with the UE. The UEs in the same group of UEs may be configured with the same positionlnDCI, so that a group of UEs may be indicated with the same SSB indicator indicating the same new SSB configuration.

FIG. 7 illustrates an example of the common DCI including multiple SSB indicators. A specific UE (e.g., a UE in a specific group of UEs) is configured with a higher layer signaling positionInDCI to indicate the position of the SSB indicator (e.g., SSB indicator #1) in the common DCI that is associated with the specific UE. When the UE receives the common DCI, the UE can identify the position of the SSB indicator #1 according to its configured higher layer signaling positionlnDCI.

Further alternatively, the common DCI may include multiple network energy saving (NES) indicators, each of which includes an SSB indicator indicating a new SSB configuration and indication(s) of other optimization information, e.g., at least one of indication of power signal information, indication of antenna port information, indication of TRP number information, indication of cell transmission ON and OFF information, etc. The UE is configured with multiple new SSB configurations, along with multiple pieces of power signal information, multiple pieces of antenna port information, multiple pieces of TRP number information, and multiple pieces of cell transmission ON and OFF information. The UE is also configured with a higher layer signaling positionInDCI to indicate the position of the NES indicator in the common DCI that is associated with the UE. The UEs in the same group of UEs may be configured with the same positionInDCI, so that a group of UEs may be indicated with the same NES indicator.

FIG. 8 illustrates an example of the common DCI including multiple NES indicators. A specific UE (e.g., a UE in a specific group of UEs) is configured with a higher layer signaling positionInDCI to indicate the position of the NES indicator (e.g., NES indicator #1) in the common DCI that is associated with the specific UE. When the UE receives the common DCI, the UE can identify the position of the NES indicator #1 according to its configured higher layer signaling positionInDCI. NES indicator #1 may include SSB indicator #n1, indication of power signal information #n2, indication of antenna port information #n3, indication of TRP number information #n4, and indication of cell transmission ON and OFF information #n5. UE further transmits or receives data based on the NES indicator after the DCI is effective or applicable.

As can be seen from the second embodiment, the indication by DCI is more applicable for group-specific UE.

A third embodiment relates to triggering of the new SSB configuration.

Two scenarios are considered. In a first scenario, only new UEs (i.e., NR Release 18 UEs) are deployed. It means that the compatibility with legacy UEs is unnecessary. In a second scenario, both new UEs and legacy UEs are deployed. It means that the compatibility with legacy UEs is necessary.

A legacy UE means a UE that assumes the SSB transmissions configured in the first SSB configuration (i.e., legacy SSB configuration) indicated by SIB are always present. On the other hand, a new UE assumes that the SSB transmissions configured in the first SSB configuration indicated by SIB can be reduced or OFF (i.e., not transmitted).

The new SSB configuration described in the first embodiment can involve at least one of two types. Type #1: additional SSBs in addition to SSBs transmitted according to the first SSB configuration are transmitted; and Type #2: some SSBs transmitted according to the first SSB configuration are reduced (or OFF, i.e., not transmitted).

For example, if the new SSB transmission periodicity is larger than the first (i.e., legacy) SSB transmission periodicity (e.g., G>1), some legacy SSB transmissions are OFF (Type #2, see FIG. 2). If the new SSB transmission periodicity is smaller than the first (i.e., legacy) SSB transmission periodicity (e.g., G<1), additional SSB transmissions are added (Type #1, see FIG. 3(b)). For another example, some legacy SSB transmissions (e.g., the SSB transmissions in the last 1 SSB burst every 80 ms) can be OFF (Type #2, see FIG. 4). For yet another example, additional SSB transmissions can be ON (i.e., added) in consecutive 2 SSB bursts after a reference time (Type #1, see FIG. 6).

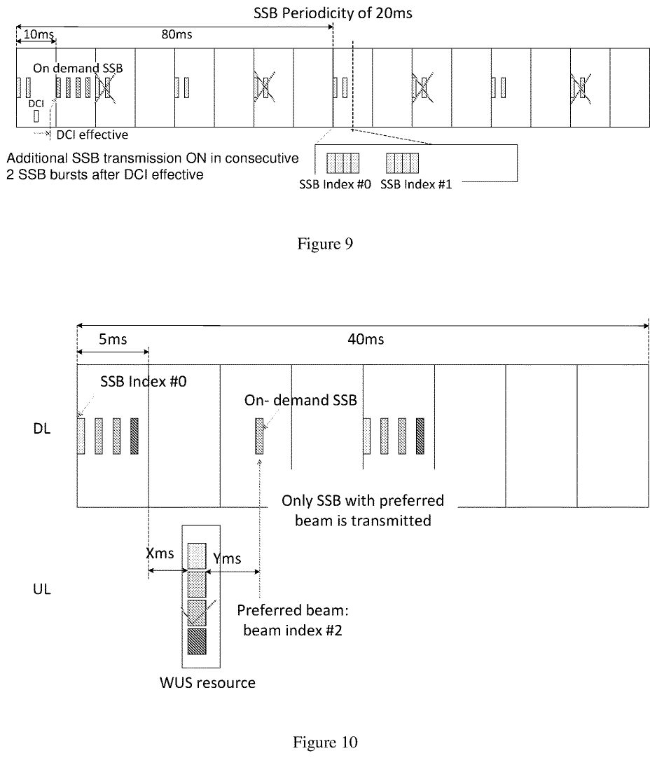

The new SSB configuration can include both type #1 and type #2 at the same time. For example, for a new SSB configuration including both new SSB transmission periodicity that is larger than the legacy SSB transmission periodicity (which involves Type #2) and new SSB transmission pattern in which additional SSB transmissions are added (which involves Type #1). FIG. 9 illustrates an example, in which the new SSB transmission periodicity (40 ms) is larger than legacy SSB transmission periodicity (20 ms), which causes SSB transmissions in the last SSB burst every 2 SSB bursts are OFF, and additional SSB transmissions are ON (i.e., added) in consecutive 2 candidate SSB bursts after the reference time (e.g., DCI effective).

In the first scenario, the compatibility with legacy UEs is unnecessary. So, the new SSB configuration with Type #1, Type #2, or both Type #1 and Type #2 is applicable. On the other hand, in the second scenario, the compatibility with legacy UEs is necessary. So, only the new SSB configuration with Type #1 is applicable.

A first sub-embodiment of the third embodiment relates to the triggering of the new SSB configuration (in Type #1 and/or Type #2) in the first scenario.

In the first scenario, the new SSB configuration is triggered upon the new SSB configuration being indicated to the UE. As described in the second embodiment, the new SSB configuration can be indicated in SIB (according to the first sub-embodiment of the second embodiment), in UE-specific RRC configuration, e.g., by a RRC signaling (according to the second sub-embodiment of the second embodiment), or in common DCI (according to the third sub-embodiment of the second embodiment).

If the new SSB configuration is indicated in SIB, it can be only indicated upon updating SI information. So, the latency of the triggering of the new SSB configuration by SIB is high.

If the new SSB configuration is indicated in UE-specific RRC configuration, the latency of the triggering of the new SSB configuration is also high, e.g., higher than the latency of DCI.

The indication of the new SSB configuration by DCI (common DCI) has lower latency.

A second sub-embodiment of the third embodiment relates to the triggering of the new SSB configuration (only in Type #1) in the second scenario.

In the second scenario, the new SSB configuration is triggered after the WUS transmission from UE. It implies that the indication of the new SSB configuration to the UE does not trigger the new SSB configuration.

According to the second sub-embodiment of the third embodiment, the new SSB configuration to the UE in the second scenario can be indicated in SIB (according to the first sub-embodiment of the second embodiment), or in UE-specific RRC configuration, e.g., by a RRC signaling (according to the second sub-embodiment of the second embodiment). The indication of the new SSB configuration does not trigger the new SSB configuration. Instead, after the WUS transmission, UE is expected to receive new SSB transmissions in the new SSB configuration in Type #1. It means that after the gNB receives the WUS transmission from the UE, gNB is expected to transmit SSBs based on the new SSB configuration. Accordingly, the new SSB transmissions in the new SSB configuration in Type #1 are transmitted. Incidentally, WUS (wake-up signal) is transmitted from a UE to gNB in a WUS resource.

According to a variety of the second sub-embodiment of the third embodiment, the new SSB configuration will be indicated and triggered to the UE in a common DCI after the WUS transmission. In particular, after the WUS transmission, the UE starts to monitor PDCCH in a window to expect to receive the common DCI including the new SSB configuration (or SSB indicator indicating the new SSB configuration or NES indicator including the SSB indicator) in the same manner as described in the third sub-embodiment of the second embodiment. For example, the UE starts to monitor PDCCH X ms (where X can be preconfigured) after the WUS transmission for a window length (which can be configured by higher layer signaling). The search space for monitoring PDCCH can be the same as other common search space or can be additionally configured.

A fourth embodiment relates to WUS resource configuration.

According to a first sub-embodiment of the fourth embodiment, the WUS resource in time domain can be configured to associate with the first SSB configuration indicated by SIB, so that the DL synchronization before WUS transmission can be facilitated.

The WUS resource can be configured periodically, where the WUS resource periodicity can be one or multiple of the first SSB transmission periodicity in the first SSB configuration. An additional time offset between the SSB transmissions in each SSB burst according to the first SSB transmission periodicity and the WUS resource can be configured by higher layer signaling.

For example, for SSB case A (see Table 1), SSB transmission starts at symbols {2, 8}+14n (where, n can be configured according to Table 1). Considering that each SSB transmission occupies 4 symbols in time domain, symbol 11+14n is the end of SSB transmissions in each SSB burst. So, the WUS resource is configured as the first uplink resource that is X symbols, which is the additional time offset (X can be preconfigured), after symbol 11+14n in each SSB burst.

For another example, the WUS resource can be configured as the first uplink resource that is X symbols, which is the additional time offset (X can be preconfigured), after each SSB burst of 5 ms in which first SSBs are transmitted. It means that the end of 5 ms can be assumed as the reference time of the WUS resource in time domain.

According to a second sub-embodiment of the fourth embodiment, the WUS resource in time domain can be configured to associate with the new SSB configuration.

When the new SSB configuration in Type #1 is indicated to the UE, the new SSB transmissions according to the new SSB configuration in Type #1 are configured. If the new SSB transmissions (i.e., the new SSB configuration in Type #1) will be triggered by WUS, the configured new SSBs are not transmitted by the gNB before the WUS is received by the gNB. Accordingly, the resource for the configured new SSBs that have not triggered by WUS can be referred to as potential additional SSB resource (or potential additional SSB resource occasions, where each potential additional SSB resource occasion refers to a resource on which a potential additional SSB is to be transmitted). For example, the first SSB transmission periodicity is configured as 10 ms, and the new SSB transmission periodicity is indicated as 5 ms. So, potential additional SSB resource is the new SSB resource between the legacy SSB resources (e.g., between two consecutive SSB bursts according to the first SSB transmission periodicity)

According to the second sub-embodiment of the fourth embodiment, the WUS resource in time domain can be configured to associate with the potential additional SSB resource determined by the new SSB configuration. It means that the WUS resource can be derived from the potential additional SSB resource. For example, the WUS resource in time domain can be Z ms (where Z can be preconfigured) before each of the potential additional SSB resource occasions.

For both the first sub-embodiment and the second sub-embodiment of the fourth embodiment, the WUS can be transmitted by only some of the beams according to the SSB transmission beam information included in the first SSB configuration or the second SSB configuration, and only the new SSB(s) associated with the preferred beam(s) (i.e., the beam(s) by which the WUS is transmitted), when triggered by the WUS transmission, are transmitted.

FIG. 10 illustrates an example of the fourth embodiment. In the example of FIG. 10, the first SSB transmission periodicity is 20 ms, and the new SSB transmission periodicity is 5 ms. A WUS is transmitted in the WUS resource that is X ms after the SSB burst of 5 ms according to the first sub-embodiment. The WUS resource is FDM configured for each beam. The WUS is transmitted by a preferred beam (e.g., beam index #2). Accordingly, an on-demand SSB (additional SSB) is transmitted Y ms after the WUS transmission, where the on-demand SSB is only transmitted by the preferred beam (e.g., beam index #2).

As a whole, according to the fourth embodiment, the WUS can be transmitted in the WUS resource configured to associate with the first SSB configuration or the second SSB configuration. The transmission of new SSBs is triggered after the transmission of the WUS according to the second sub-embodiment of the third embodiment, or the new SSB configuration is indicated and triggered in the common DCI after the transmission of the WUS according to the variety of the second sub-embodiment of the third embodiment.

In addition, in case of TDD, if any symbol on which the new SSBs are transmitted is not available for downlink transmission, the symbol for SSB transmission is punctured.

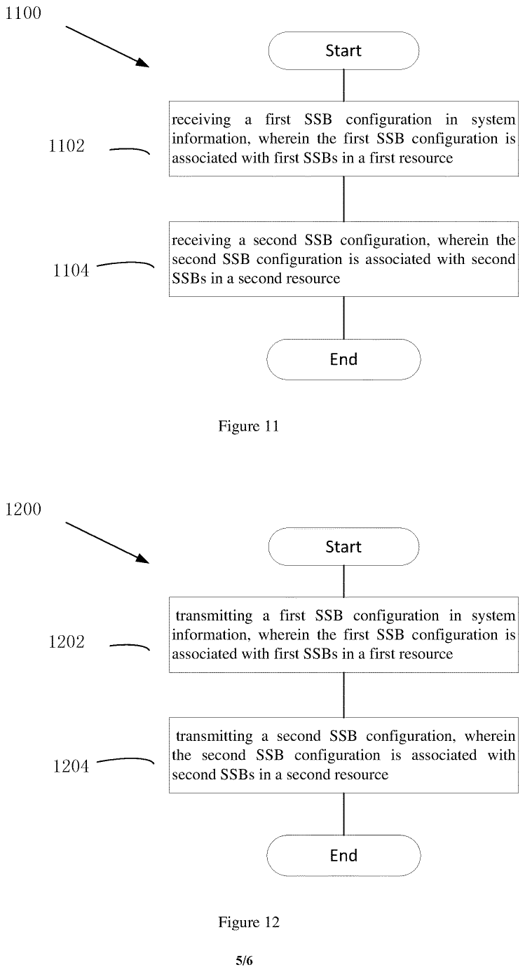

FIG. 11 is a schematic flow chart diagram illustrating an embodiment of a method 1100 according to the present application. In some embodiments, the method 1100 is performed by an apparatus, such as a remote unit (UE). In certain embodiments, the method 1100 may be performed by a processor executing program code, for example, a microcontroller, a microprocessor, a CPU, a GPU, an auxiliary processing unit, a FPGA, or the like.

The method 1100 may include 1102 receiving a first SSB configuration in system information, wherein the first SSB configuration is associated with first SSBs in a first resource; and 1104 receiving a second SSB configuration, wherein the second SSB configuration is associated with second SSBs in a second resource. In some embodiment, the second SSBs are additional SSBs in addition to the first SSBs and/or reduction(s) from the first SSBs.

In some embodiment, the method comprises receiving the second SSB configuration in an RRC signaling message or in a control signal.

In some embodiment, the method comprises receiving multiple second SSB configurations in an RRC signaling message, and the method further comprises receiving an SSB indicator indicating one of the multiple second SSB configurations based on a position index indicating the position of the one second SSB configuration in a control signal. In some embodiment, the SSB indicator is included in a network energy saving indicator based on a position index indicating the position of the network energy saving indicator in the control signal, and the network energy saving indicator further includes at least one of indication of power signal information, indication of antenna port information, indication of TRP number information, and indication of cell transmission ON and OFF information.

In some embodiment, the second SSB configuration includes at least one of SSB transmission physical resource, SSB transmission pattern, and SSB transmission beam information. The SSB transmission physical resource may include second SSB transmission periodicity, or a scaling factor to a reference SSB transmission periodicity which is one of SSB transmission periodicity of the first SSBs, a reference periodicity configured by higher layer, and a default SSB transmission periodicity. The SSB transmission pattern may include SSB transmissions OFF or ON in the first or the last M1 SSB bursts within a configured period, SSB transmissions OFF or ON for M2 SSB bursts from a first reference time, and additional SSB transmission in consecutive M3 SSB bursts after a second reference time, where, each of M1, M2 and M3 is a preconfigured positive integer.

In some embodiment, the method further comprises transmitting a WUS in a WUS resource, and the WUS resource is associated with the first SSB configuration or the second SSB configuration. The method may further comprise monitoring a control signal after the WUS transmission within a window length, the window length is configured by higher layer. The WUS resource may be determined by the first SSB resource or the second SSB resource. In particular, the WUS resource is a first time offset after the first SSB resource or a second time offset before the second SSB resource. The periodicity of the WUS resource may be one or multiple of the periodicity of the first SSB resource or the second SSB resource. The WUS resource may be associated with SSB beam(s), and the second SSB(s) in the second SSB resource are associated with the SSB beam(s).

FIG. 12 is a schematic flow chart diagram illustrating a further embodiment of a method 1200 according to the present application. In some embodiments, the method 1200 is performed by an apparatus, such as a base unit. In certain embodiments, the method 1200 may be performed by a processor executing program code, for example, a microcontroller, a microprocessor, a CPU, a GPU, an auxiliary processing unit, a FPGA, or the like.

The method 1200 may include 1202 transmitting a first SSB configuration in system information, wherein the first SSB configuration is associated with first SSBs in a first resource; and 1204 transmitting a second SSB configuration, wherein the second SSB configuration is associated with second SSBs in a second resource. In some embodiment, the second SSBs are additional SSBs in addition to the first SSBs and/or reduction(s) from the first SSBs.

In some embodiment, the method comprises transmitting the second SSB configuration in an RRC signaling message or in a control signal.

In some embodiment, the method comprises transmitting multiple second SSB configurations in an RRC signaling message, and the method further comprises transmitting an SSB indicator indicating one of the multiple second SSB configurations based on a position index indicating the position of the one second SSB configuration in a control signal. In some embodiment, the SSB indicator is included in a network energy saving indicator based on a position index indicating the position of the network energy saving indicator in the control signal, and the network energy saving indicator further includes at least one of indication of power signal information, indication of antenna port information, indication of TRP number information, and indication of cell transmission ON and OFF information.

In some embodiment, the second SSB configuration includes at least one of SSB transmission physical resource, SSB transmission pattern, and SSB transmission beam information. The SSB transmission physical resource may include second SSB transmission periodicity, or a scaling factor to a reference SSB transmission periodicity which is one of SSB transmission periodicity of the first SSBs, a reference periodicity configured by higher layer, and a default SSB transmission periodicity. The SSB transmission pattern may include SSB transmissions OFF or ON in the first or the last M1 SSB bursts within a configured period, SSB transmissions OFF or ON for M2 SSB bursts from a first reference time, and additional SSB transmission in consecutive M3 SSB bursts after a second reference time, where, each of M1, M2 and M3 is a preconfigured positive integer.

In some embodiment, the method further comprises receiving a WUS in a WUS resource, and the WUS resource is associated with the first SSB configuration or the second SSB configuration. The method may further comprise transmitting a control signal after the WUS reception within a window length. The WUS resource may be determined by the first SSB resource or the second SSB resource. In particular, the WUS resource is a first time offset after the first SSB resource or a second time offset before the second SSB resource. The periodicity of the WUS resource may be one or multiple of the periodicity of the first SSB resource or the second SSB resource. The WUS resource may be associated with SSB beam(s), and the second SSB(s) in the second SSB resource are associated with the SSB beam(s).

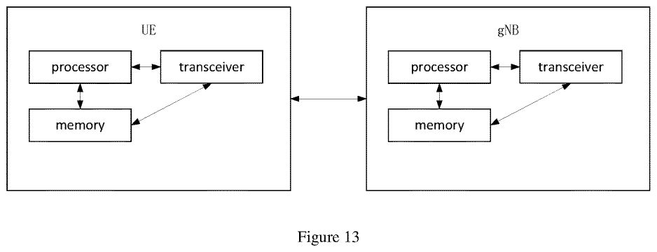

FIG. 13 is a schematic block diagram illustrating apparatuses according to one embodiment.

Referring to FIG. 13, the UE (i.e., the remote unit) includes a processor, a memory, and a transceiver. The processor implements a function, a process, and/or a method which are proposed in FIG. 11.

The UE comprises a transceiver; and a processor coupled to the transceiver, wherein the processor is configured to receive, via the transceiver, a first SSB configuration in system information, wherein the first SSB configuration is associated with first SSBs in a first resource; and receive, via the transceiver, a second SSB configuration, wherein the second SSB configuration is associated with second SSBs in a second resource. In some embodiment, the second SSBs are additional SSBs in addition to the first SSBs and/or reduction(s) from the first SSBs.

In some embodiment, the processor is configured to receive, via the transceiver, the second SSB configuration in an RRC signaling message or in a control signal.

In some embodiment, the processor is configured to receive, via the transceiver, multiple second SSB configurations in an RRC signaling message, and the processor is further configured to receive, via the transceiver, an SSB indicator indicating one of the multiple second SSB configurations based on a position index indicating the position of the one second SSB configuration in a control signal. In some embodiment, the SSB indicator is included in a network energy saving indicator based on a position index indicating the position of the network energy saving indicator in the control signal, and the network energy saving indicator further includes at least one of indication of power signal information, indication of antenna port information, indication of TRP number information, and indication of cell transmission ON and OFF information.

In some embodiment, the second SSB configuration includes at least one of SSB transmission physical resource, SSB transmission pattern, and SSB transmission beam information. The SSB transmission physical resource may include second SSB transmission periodicity, or a scaling factor to a reference SSB transmission periodicity which is one of SSB transmission periodicity of the first SSBs, a reference periodicity configured by higher layer, and a default SSB transmission periodicity. The SSB transmission pattern may include SSB transmissions OFF or ON in the first or the last M1 SSB bursts within a configured period, SSB transmissions OFF or ON for M2 SSB bursts from a first reference time, and additional SSB transmission in consecutive M3 SSB bursts after a second reference time, where, each of M1, M2 and M3 is a preconfigured positive integer.

In some embodiment, the processor is further configured to transmit, via the transceiver, a WUS in a WUS resource, and the WUS resource is associated with the first SSB configuration or the second SSB configuration. The processor may be further configured to monitor, via the transceiver, a control signal after the WUS transmission within a window length, the window length is configured by higher layer. The WUS resource may be determined by the first SSB resource or the second SSB resource. In particular, the WUS resource is a first time offset after the first SSB resource or a second time offset before the second SSB resource. The periodicity of the WUS resource may be one or multiple of the periodicity of the first SSB resource or the second SSB resource. The WUS resource may be associated with SSB beam(s), and the second SSB(s) in the second SSB resource are associated with the SSB beam(s).

Referring to FIG. 13, the gNB (i.e., base unit) includes a processor, a memory, and a transceiver. The processors implement a function, a process, and/or a method which are proposed in FIG. 12.

The base unit comprises a processor; and a transceiver coupled to the processor, wherein the processor is configured to transmit, via the transceiver, a first SSB configuration in system information, wherein the first SSB configuration is associated with first SSBs in a first resource; and transmit, via the transceiver, a second SSB configuration, wherein the second SSB configuration is associated with second SSBs in a second resource. In some embodiment, the second SSBs are additional SSBs in addition to the first SSBs and/or reduction(s) from the first SSBs.

In some embodiment, the processor is configured to transmit, via the transceiver, the second SSB configuration in an RRC signaling message or in a control signal.

In some embodiment, the processor is configured to transmit, via the transceiver, multiple second SSB configurations in an RRC signaling message, and the processor is further configured to transmit, via the transceiver, an SSB indicator indicating one of the multiple second SSB configurations based on a position index indicating the position of the one second SSB configuration in a control signal. In some embodiment, the SSB indicator is included in a network energy saving indicator based on a position index indicating the position of the network energy saving indicator in the control signal, and the network energy saving indicator further includes at least one of indication of power signal information, indication of antenna port information, indication of TRP number information, and indication of cell transmission ON and OFF information.

In some embodiment, the second SSB configuration includes at least one of SSB transmission physical resource, SSB transmission pattern, and SSB transmission beam information. The SSB transmission physical resource may include second SSB transmission periodicity, or a scaling factor to a reference SSB transmission periodicity which is one of SSB transmission periodicity of the first SSBs, a reference periodicity configured by higher layer, and a default SSB transmission periodicity. The SSB transmission pattern may include SSB transmissions OFF or ON in the first or the last M1 SSB bursts within a configured period, SSB transmissions OFF or ON for M2 SSB bursts from a first reference time, and additional SSB transmission in consecutive M3 SSB bursts after a second reference time, where, each of M1, M2 and M3 is a preconfigured positive integer.

In some embodiment, the processor is further configured to receive, via the transceiver, a WUS in a WUS resource, and the WUS resource is associated with the first SSB configuration or the second SSB configuration. The processor may be configured to transmit, via the transceiver, a control signal after the WUS reception within a window length. The WUS resource may be determined by the first SSB resource or the second SSB resource. In particular, the WUS resource is a first time offset after the first SSB resource or a second time offset before the second SSB resource. The periodicity of the WUS resource may be one or multiple of the periodicity of the first SSB resource or the second SSB resource. The WUS resource may be associated with SSB beam(s), and the second SSB(s) in the second SSB resource are associated with the SSB beam(s).

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a first synchronization signal block (SSB) configuration in system information, wherein the first SSB configuration is associated with first SSBs in a first resource; and
receive a second SSB configuration, wherein the second SSB configuration is associated with second SSBs in a second resource.

2. The UE of claim 1, wherein the at least one processor is configured to cause the UE to receive the second SSB configuration in radio resource control (RRC) signaling message or in a control signal.

3. The UE of claim 1, wherein the at least one processor is configured to cause the UE to:
receive multiple second SSB configurations in radio resource control (RRC) signaling message, and
receive, via the transceiver, an SSB indicator indicating one of the multiple second SSB configurations based on a position index indicating the position of the one second SSB configuration in a control signal.

4. The UE of claim 4, wherein the SSB indicator is included in a network energy saving indicator based on a position index indicating the position of the network energy saving indicator in the control signal, and the network energy saving indicator further includes at least one of indication of power signal information, indication of antenna port information, indication of transmission and reception point (TRP) number information, and indication of cell transmission ON and OFF information.

5. The UE of claim 1, wherein the second SSB configuration includes at least one of SSB transmission physical resource, SSB transmission pattern, and SSB transmission beam information.

6. The UE of claim 5, wherein the SSB transmission physical resource includes second SSB transmission periodicity, or a scaling factor to a reference SSB transmission periodicity which is one of SSB transmission periodicity of the first SSBs, a reference periodicity configured by higher layer, and a default SSB transmission periodicity.

7. The UE of claim 5, wherein the SSB transmission pattern includes SSB transmissions OFF or ON in the first or the last M1 SSB bursts within a configured period, SSB transmissions OFF or ON for M2 SSB bursts from a first reference time, and additional SSB transmission in consecutive M3 SSB bursts after a second reference time, where, each of M1, M2 and M3 is a preconfigured positive integer.

8. The UE of claim 1, wherein the at least one processor is configured to cause the UE to:
transmit a wake-up-signal (WUS) in a WUS resource,
wherein the WUS resource is associated with the first SSB configuration or the second SSB configuration.

9. The UE of claim 8, wherein the at least one processor is configured to cause the UE to monitor a control signal after the WUS transmission within a window length, the window length is configured by higher layer.

10. The UE of claim 8, wherein the WUS resource is determined by the first SSB resource or the second SSB resource.

11. The UE of claim 10, wherein the WUS resource is a first time offset after the first SSB resource or a second time offset before the second SSB resource.

12. The UE of claim 8, wherein the periodicity of the WUS resource is one or multiple of the periodicity of the first SSB resource or the second SSB resource.

13. The UE of claim 8, wherein the WUS resource is associated with SSB beam(s), and the second SSB(s) in the second SSB resource are associated with the SSB beam(s).

14. A method performed by a user equipment (UE), the method comprising:
receiving a first synchronization signal block (SSB) configuration in system information, wherein the first SSB configuration is associated with first SSBs in a first resource; and
receiving a second SSB configuration, wherein the second SSB configuration is associated with second SSBs in a second resource.

15. A base station, comprising:
at least one memory; and
at least one processor coupled with the at least one memory and configured to cause the base station to:
transmit a first synchronization signal block (SSB) configuration in system information, wherein the first SSB configuration is associated with first SSBs in a first resource; and
transmit a second SSB configuration, wherein the second SSB configuration is associated with second SSBs in a second resource.

16. A processor for wireless communication, comprising:
at least one controller coupled with at least one memory and configured to cause the processor to:
receive a first synchronization signal block (SSB) configuration in system information, wherein the first SSB configuration is associated with first SSBs in a first resource; and
receive a second SSB configuration, wherein the second SSB configuration is associated with second SSBs in a second resource.

17. The processor of claim 16, wherein the at least one controller is configured to cause the processor to receive the second SSB configuration in radio resource control (RRC) signaling message or in a control signal.

18. The processor of claim 16, wherein the at least one controller is configured to cause the processor to:
receive multiple second SSB configurations in radio resource control (RRC) signaling message, and
receive, via the transceiver, an SSB indicator indicating one of the multiple second SSB configurations based on a position index indicating the position of the one second SSB configuration in a control signal.

19. The processor of claim 18, wherein the SSB indicator is included in a network energy saving indicator based on a position index indicating the position of the network energy saving indicator in the control signal, and the network energy saving indicator further includes at least one of indication of power signal information, indication of antenna port information, indication of transmission and reception point (TRP) number information, and indication of cell transmission ON and OFF information.

20. The processor of claim 16, wherein the second SSB configuration includes at least one of SSB transmission physical resource, SSB transmission pattern, and SSB transmission beam information.
